(19) United States
(12) Patent Application Publication
(10) Pub. No.: US 2025/0021910 A1
(43) Pub. Date: Jan. 16, 2025

(54) METHOD FOR CALCULATING CARBON EMISSIONS OF OIL-IMMERSED POWER TRANSFORMER, ELECTRONIC DEVICE AND COMPUTER-READABLE STORAGE MEDIUM

(71) Applicant: ECONOMIC RESEARCH INSTITUTE OF STATE GRID ZHEJIANG ELECTRIC POWER COMPANY, Hangzhou, Zhejiang Province (CN)

(72) Inventors: Meijin GAO, Hangzhou, Zhejiang Province (CN); Yanqun LIANG, Hangzhou, Zhejiang Province (CN); Wendong LI, Hangzhou, Zhejiang Province (CN); Tingting WANG, Hangzhou, Zhejiang Province (CN); Chao WANG, Hangzhou, Zhejiang Province (CN)

(73) Assignee: ECONOMIC RESEARCH INSTITUTE OF STATE GRID ZHEJIANG ELECTRIC POWER COMPANY, Hangzhou, Zhejiang Province (CN)

(21) Appl. No.: 18/713,077

(22) PCT Filed: Jul. 11, 2023
(86) PCT No.: PCT/CN2023/106821

§ 371 Date: May 23, 2024

(30) Foreign Application Priority Data
Jun. 25, 2023 (CN) 202310754479.7

(51) Int. Cl. G06Q 10/0637; G06F 17/11; G06Q 30/018

(52) U.S. Cl. CPC G06Q 10/06375; G06F 17/11; G06Q 30/018

(57) ABSTRACT

A method for calculating carbon emissions of oil-immersed power transformer. The method includes: obtaining operation data of the oil-immersed power transformer; determining input parameters according to the operating data; the input parameters include: a load power P of the oil-immersed power transformer, a three-phase current balance ε, and a harmonic distortion rate THD; obtaining a top oil temperature Tₜₒₚ of the oil-immersed power transformer; determining an average temperature T_{wnd} and a temperature correction coefficient Kₜₑₘₚ of a winding of the oil-immersed power transformer according to the top oil temperature Tₜₒₚ; determining an electrical energy loss S of the oil-immersed power transformer based on the input parameters, the average temperature T_{wnd}, and the temperature correction coefficient Kₜₑₘₚ; determining the carbon emission G of the oil-immersed power transformer according to the electrical energy loss S.

### CROSS-REFERENCE TO RELATED APPLICATIONS

This application is a 35 U.S.C. § 371 national stage application of PCT patent application No. PCT/CN2023/106821, filed on Jul. 11, 2023, which claims priority to Chinese patent application No. 202310754479.7, filed on Jun. 25, 2023, and entitled “method and apparatus for calculating carbon emissions, electronic device and readable storage medium”, the entire contents of which is incorporated herein by reference.

### TECHNICAL FIELD

The present application relates to the technical field of calculation of carbon emission, and more particularly, to a method for calculating carbon emissions of an oil-immersed power transformer, an electronic device and a computer-readable storage medium.

### BACKGROUND

With the rapid development of national economy, energy consumption has been increasing year by year. High energy consuming industries (e.g., power industry) have high carbon emissions and are key areas for carbon emission control.

In the power industry, a power transformer is a hub for power transmission and conversion. The power transformer generates a large amount of energy loss during operation, thereby resulting in a large amount of carbon emissions of carbon dioxide. Under the guidance of carbon peak and carbon neutrality strategic goals, reducing and suppressing carbon emissions of the power transformer has significant practical significance.

It should be noted that, the carbon emissions during an operation stage of the power transformer account for a majority of the emissions in the total lifecycle of the power transformer. Therefore, the key to reduce the carbon emissions from the power transformer lies in the effective suppression of energy loss during the operation stage of the power transformer. Thus, it is necessary to finely calculate the carbon emissions during the operation stage of the power transformer. Currently, the calculation of carbon emissions caused by the overall loss of the power grid (i.e., “grid loss”) using relevant technologies is relatively mature. However, the evaluation of carbon emissions of the transformer under operating conditions is relatively lagging, and a calculation result of the carbon emissions is not accurate.

Therefore, how to improve the accuracy of calculation of the carbon emissions of power transformer is a technical problem that needs to be solved urgently.

### SUMMARY

The present application provides a method for calculating carbon emissions of an oil-immersed power transformer, an electronic device and a computer-readable storage medium, which can improve an accuracy of carbon emissions of the oil-immersed power transformer.

In the first aspect, a method for calculating carbon emissions of an oil-immersed power transformer is provided in the embodiments of the present application. The method includes:
obtaining operation data of the oil-immersed power transformer; the operation data includes: an operating voltage, an operating current, and a power factor of the oil-immersed power transformer;
determining input parameters according to the operating data; the input parameters include: a load power P of the oil-immersed power transformer, a three-phase current balance ε, and a harmonic distortion rate THD;
obtaining a top oil temperature Tₜₒₚ of the oil-immersed power transformer;
determining an average temperature T_{wnd} and a temperature correction coefficient Kₜₑₘₚ of a winding of the oil-immersed power transformer according to the top oil temperature Tₜₒₚ;
determining an electrical energy loss S of the oil-immersed power transformer based on the input parameters, the average temperature T_{wnd}, and the temperature correction coefficient Kₜₑₘₚ; and
determining the carbon emission G of the oil-immersed power transformer based on the electrical energy loss S.

In the present application, when carbon emissions are calculated, the required input may be obtained from nameplate data of equipment, factory test data, and three-phase voltage and current data in the power recording system, which is applicable for rapid estimation of carbon emissions of on-site power transformers with high accuracy.

In combination with the first aspect, in some implementations of the first aspect, said determining the input parameters according to the operation data includes:

$$P = {U}_{a} {I}_{a} cos {φ}_{a} + {U}_{b} {I}_{b} cos {φ}_{b} + {U}_{c} {I}_{c} cos {φ}_{c}$$

$$ε = {( {I}_{a} - {I}_{b} )}^{2} + {( {I}_{a} - {I}_{c} )}^{2} + {( {I}_{b} - {I}_{c} )}^{2}$$

$$THD = \sqrt{{\sum }_{i = 2}^{n} {I}_{i}^{2}} / {I}_{1} \times 100 \%$$

wherein, the Iᵢ (i≥2) represents an effective value of an i-th harmonic current of a current waveform, I₁ represents an effective value of a fundamental current of 50 Hz; the Uₐ, the U_{b}, and the U_{c} represent effective values of three-phase voltages of a, b, and c; the Iₐ, the I_{b}, and the I_{c} represent effective values of three-phase currents of a, b, and c; the cosφa, the cosφb, the cosφc represent three-phase power factors.

In combination with the first aspect, in some implementations of the first aspect, said determining the average temperature T_{wnd} and the temperature correction coefficient Kₜₑₘₚ of the winding of the oil-immersed power transformer according to the top oil temperature Tₜₒₚ includes:

$${T}_{wnd} = {T}_{top} - Δ {T}_{top - oil} + Δ {T}_{wnd - oil} = {T}_{top} - {( \frac{1 + {R ( P / {P}_{std} )}^{2}}{1 + R} )}^{x} Δ {T}_{t - o - std} + {( \frac{P}{{P}_{std}} )}^{y} Δ {T}_{w - o - std}$$

wherein, ΔTₜₒₚ₋ₒᵢₗ represents a difference value between the top oil temperature Tₜₒₚ and the average oil temperature T_{wnd}, ΔT_{wnd-oil} represents a difference value between an average temperature of the winding and the average oil temperature T_{wnd}, P_{std} represents a rated capacity of the oil-immersed power transformer, the R represents a loss ratio which is a ratio of the load loss of the oil-immersed power transformer to a no-load loss of the oil-immersed power transformer, ΔT_{t-o-std} and ΔT_{w-o-std} are ΔTₜₒₚ₋ₒᵢₗ and ΔT_{wnd-oil} of the oil-immersed power transformer at a rated voltage and a rated current, x and y are correction coefficients of oil temperature rise and winding temperature rise, respectively;

$${K}_{temp} = \frac{{T}_{wnd} + C}{{T}_{wnd - std} + C}$$

Wherein, T_{wnd} represents the average temperature of the winding at a rated state, with a reference value of 85° C.; C represents a coefficient related to the material of the winding, 235 is selected for the winding having copper material, and 225 is selected for the winding having an aluminum material.

In the calculation process of carbon emissions in this embodiment, the average temperature of the winding is determined based on the top oil temperature data of the transformer, then, the load loss (copper loss) is corrected, which is conducive to improving the accuracy of calculation of the carbon emissions.

In combination with the first aspect, in some implementations of the first aspect, said determining the electrical energy loss S of the oil-immersed power transformer according to the input parameters, the average temperature T_{wnd}, and the temperature correction coefficient Kₜₑₘₚ comprises:

$$S = {K}_{temp} {P}_{c} + {P}_{i} + {K}_{temp} Δ {P}_{c 1} + Δ {P}_{i 1} + {K}_{temp} Δ {P}_{c 2} + Δ {P}_{i 2} = {{K}_{t e m p} ( \frac{P}{{P}_{std}} )}^{2} {P}_{c} + {P}_{i} + {K}_{temp \_ 1} {R}_{1} ε / 3 + {K}_{F e 1} {R}_{F e} ε + {K}_{temp} {THD ( \frac{P}{{P}_{std}} )}^{2} {P}_{c} + {K}_{i \_ THD} {THDP}_{i}$$

wherein, P_{c} is the load loss at the rated state, and Pᵢ is the no-load loss at the rated state; ΔP_{c1} represents an additional copper loss when three-phase imbalance is considered, K_{temp_1}−(T_{wnd}+C)/(T_{R1_std}+C) represents a temperature correction coefficient of a direct current resistance of a secondary winding, T_{R1_std} represents an ambient temperature during testing of the direct current resistance of the secondary winding; ΔPᵢ₁ represents an additional iron loss when the three-phase imbalance is considered, which is obtained through an equivalent resistance value R_{Fe} of an eddy current loss between a clamp and an oil tank, an additional iron loss coefficient K_{Fe1}, and the three-phase current balance ε, the R_{Fe} and K_{Fe1} are calculated by a manufacturer through numerical analysis and calculation of electromagnetic field of the transformer; ΔP_{c2} represents the additional copper loss with the consideration of harmonics; ΔPᵢ₂ represents the additional iron loss with the consideration of harmonics, and K_{i_THD} is calculated by the manufacturer through the numerical analysis of the electromagnetic field of the transformer.

In this embodiment, the influences of harmonics and three-phase imbalance characteristics are considered, a calculation formula for the power loss of oil-immersed power transformer is proposed.

In combination with the first aspect, in some implementations of the first aspect, said determining the carbon emission G of the oil-immersed power transformer according to the electrical energy loss S includes:
calculating the carbon emissions of the oil-immersed power transformer within a certain time period;

$$G = S \cdot {t}_{R} \cdot EF$$

wherein t_{R} represents the operating time, EF represents a carbon emission factor of a power grid which is calculated according to public data from various environmental departments in various regions.

In this embodiment, data of carbon emissions are obtained according to the power loss of the oil-immersed power transformer.

In the second aspect, an apparatus for calculating carbon emissions is provided in one embodiment of the present application, the calculation apparatus is used for calculating the carbon emissions of an oil-immersed power transformer and includes:
a first obtaining unit configured to obtain operation data of the oil-immersed power transformer; the operation data comprises: an operating voltage, an operating current, and a power factor of the oil-immersed power transformer;
a first processing unit configured to determine input parameters based on the operating data; the input parameters comprise: a load power P of the oil-immersed power transformer, a three-phase current balance ε, and a harmonic distortion rate THD;
a second obtaining unit configured to obtain a top oil temperature Tₜₒₚ of the oil-immersed power transformer;
a second processing unit configured to determine an average temperature T_{wnd} and a temperature correction coefficient Kₜₑₘₚ of a winding of the oil-immersed power transformer according to the top oil temperature Tₜₒₚ, and determine an electrical energy loss S of the oil-immersed power transformer based on the input parameters, the average temperature T_{wnd}, and the temperature correction coefficient Kₜₑₘₚ; and determine the carbon emission G of the oil-immersed power transformer according to the electrical energy loss S.

In the present application, when carbon emissions are calculated, the required input may be obtained from nameplate data of equipment, factory test data, and three-phase voltage and current data in the power recording system, which is applicable for rapid estimation of carbon emissions of on-site power transformers with high accuracy.

In combination with the second aspect, in some implementations of the second aspect, the first processing unit may determine the input parameters through an expression listed below:
regarding determining the input parameters according to the operation data, the first processing unit is specifically configured to calculate the input parameters through an expression listed below:

$$P = {U}_{a} {I}_{a} cos {φ}_{a} + {U}_{b} {I}_{b} cos {φ}_{b} + {U}_{c} {I}_{c} cos {φ}_{c}$$

$$ε = {( {I}_{a} - {I}_{b} )}^{2} + {( {I}_{a} - {I}_{c} )}^{2} + {( {I}_{b} - {I}_{c} )}^{2}$$

$$THD = \sqrt{{\sum }_{i = 2}^{n} {I}_{i}^{2}} / {I}_{1} \times 100 \%$$

wherein, the Iᵢ (i≥2) represents an effective value of an i-th harmonic current of a current waveform, the I₁ represents an effective value of a fundamental current of 50 Hz; the Uₐ, the U_{b}, and the U_{c} represent effective values of three-phase voltages of a, b, and c; the Iₐ, the I_{b}, and the I_{c} represent effective values of three-phase currents of a, b, and c; the cosφa, the cosφb, the cosφc represent three-phase power factors, respectively.

In combination with the second aspect, in some implementations of the second aspect, regarding determining the average temperature T_{wnd} and the temperature correction coefficient Kₜₑₘₚ of the winding of the oil-immersed power transformer according to the top oil temperature Tₜₒₚ, the second processing unit is specifically configured to determine the average temperature T_{wnd} and the temperature correction coefficient Kₜₑₘₚ of the winding of the oil-immersed power transformer through an expression listed below:

$${T}_{wnd} = {T}_{top} - Δ {T}_{top - oil} + Δ {T}_{wnd - oil} = {T}_{top} - {( \frac{1 + {R ( P / {P}_{std} )}^{2}}{1 + R} )}^{x} Δ {T}_{t - o - std} + {( \frac{P}{{P}_{std}} )}^{y} Δ {T}_{w - o - std}$$

wherein ΔTₜₒₚ₋ₒᵢₗ represents a difference value between the top oil temperature Tₜₒₚ and the average oil temperature T_{wnd}, ΔT_{wnd-oil} represents a difference value between an average temperature of the winding and the average oil temperature T_{wnd}, P_{std} represents a rated capacity of the oil-immersed power transformer, R represents a loss ratio which is a ratio of the load loss of the oil-immersed power transformer to a no-load loss of the oil-immersed power transformer, ΔT_{t-o-std} and ΔT_{w-o-std} are ΔTₜₒₚ₋ₒᵢₗ and ΔT_{wnd-oil} of the oil-immersed power transformer at a rated voltage and a rated current, x and y are correction coefficients of oil temperature rise and winding temperature rise, respectively;

$${K}_{temp} = \frac{{T}_{wnd} + C}{{T}_{wnd - std} + C}$$

Wherein, T_{wnd} represents the average temperature of the winding at a rated state, with a reference value of 85° C.; C represents a coefficient related to the material of the winding, 235 is selected for the winding having copper material, and 225 is selected for the winding having an aluminum material.

In combination with the second aspect, in some implementations of the second aspect, said determining the electrical energy loss S of the oil-immersed power transformer according to the input parameters, the average temperature T_{wnd}, and the temperature correction coefficient Kₜₑₘₚ includes:

$$S = {K}_{temp} {P}_{c} + {P}_{i} + {K}_{temp} Δ {P}_{c 1} + Δ {P}_{i 1} + {K}_{temp} Δ {P}_{c 2} + Δ {P}_{i 2} = {{K}_{temp} ( \frac{P}{{P}_{std}} )}^{2} {P}_{c} + {P}_{i} + {K}_{temp \_ 1} {R}_{1} ε / 3 + {K}_{F e 1} {R}_{F e} ε + {K}_{temp} {THD ( \frac{P}{{P}_{std}} )}^{2} {P}_{c} + {K}_{i \_ THD} {THDP}_{i}$$

wherein, P_{c} is the load loss at the rated state, and the Pᵢ is the no-load loss at the rated state; ΔP_{c1} represents an additional copper loss when three-phase imbalance is considered, K_{temp_1}=(T_{wnd}+C)/(T_{R1_std}+C) represents a temperature correction coefficient of a direct current resistance of a secondary winding, T_{R1_std} represents an ambient temperature during testing of the direct current resistance of the secondary winding; ΔPᵢ₁ represents an additional iron loss when the three-phase imbalance is considered, which is obtained through an equivalent resistance value R_{Fe} of an eddy current loss between a clamp and an oil tank, an additional iron loss coefficient K_{Fe1}, and the three-phase current balance ε, R_{Fe} and K_{Fe1} are calculated by a manufacturer through numerical analysis and calculation of electromagnetic field of the transformer; ΔP_{c2} represents the additional copper loss with the consideration of harmonics; ΔPᵢ₂ represents the additional iron loss with the consideration of harmonics, and K_{i_THD} is calculated by the manufacturer through the numerical analysis of the electromagnetic field of the transformer.

In this embodiment, the influences of harmonics and three-phase imbalance characteristics are considered, a calculation formula for the power loss of oil-immersed power transformer is proposed.

In combination with the second aspect, in some implementations of the second aspect, said determining the carbon emission G of the oil-immersed power transformer according to the electrical energy loss S includes:
calculating the carbon emissions of the oil-immersed power transformer within a certain time period;

$$G = S \cdot {t}_{R} \cdot EF$$

wherein t_{R} represents the operating time, EF represents a carbon emission factor of a power grid which is calculated according to public data from various environmental departments in various regions.

In this embodiment, data of carbon emissions are obtained according to the power loss of the oil-immersed power transformer.

In the third aspect, an electronic device is provided in the embodiments of the present application. The electronic device includes a memory and one or a plurality of processor(s) coupled with the memory; wherein the memory stores a computer program code, the computer program code includes a computer instruction. When the computer instruction is executed by the processor, the electronic device is caused to perform the method for calculating carbon emissions according to any possible implementation manner in the first aspect or the second aspect.

In the fourth aspect, a non-transitory computer-readable storage medium is provided in the embodiments of the present application. Wherein the computer-readable storage medium stores a computer instruction, that, when being executed on an electronic device, causes the electronic device to perform the method for calculating carbon emissions according to any possible implementation manner in the first aspect or the second aspect.

It can be understood that, regarding the beneficial effects that can be achieved by the apparatus for calculating carbon emissions in the second aspect, the electronic device in the third aspect and the computer-readable storage medium in the fourth aspect, reference can be made to the any possible implementation manner in the first aspect. The beneficial effects are not repeatedly described here.

### DESCRIPTION OF THE DRAWINGS

FIG. 1 illustrates a schematic flow diagram of a method for calculating carbon emissions in one embodiment of the present application.

### DETAILED DESCRIPTION OF EMBODIMENTS

In order to make the objective, the technical solutions and the advantages of the present application be clearer, the embodiments of the present application will be described in detail below with reference to the accompanying drawings.

Terms of “comprising/including” and any modification thereof in the description, claims and the aforesaid accompanying drawings are intended to cover non-exclusive inclusion, such as including a process of a series of steps or units, a method or a system, a product or a device, which is not limited to the listed steps or units, but optionally further includes the steps or units that are not listed, or optionally further includes other steps or elements inherent to these processes, method, product or device. In addition, terms of “first”, “second”, and “third” are configured to distinguish different objects rather than describing a particular order.

When calculating the carbon emission, in the related solution, the additional loss caused by harmonic and three-phase imbalance in an operation process of an oil-immersed power transformer is usually unconsidered; and/or the influence caused by temperature change of the device in the operation process are not considered; and/or parameters required by a calculation model are complex and diversified, and it is difficult to obtain the parameters from power equipment and power grid system on site. These deficiencies enable the accuracy of the result obtained by the method for calculating carbon emissions to be undetermined.

In order to solve the above problem, according to the method for calculating carbon emissions provided in the present application, a load power of the transformer, a three-phase current balance and a harmonic distortion rate are calculated based on the real-time monitoring data of the voltage, the current and the top oil temperature of the on-site oil-immersed power transformer. Then, the loss power of the equipment can be accurately obtained by substituting the three parameters (i.e., the voltage, the current and the top oil temperature) into a calculation formula of power loss. Finally, the loss power is combined with a carbon emission factor of the power grid, such that a value of carbon emissions of the oil-immersed power transformer in a certain period of time may be accurately obtained, which is provided as a reference for analysis and reduction of carbon emission of the power transformer.

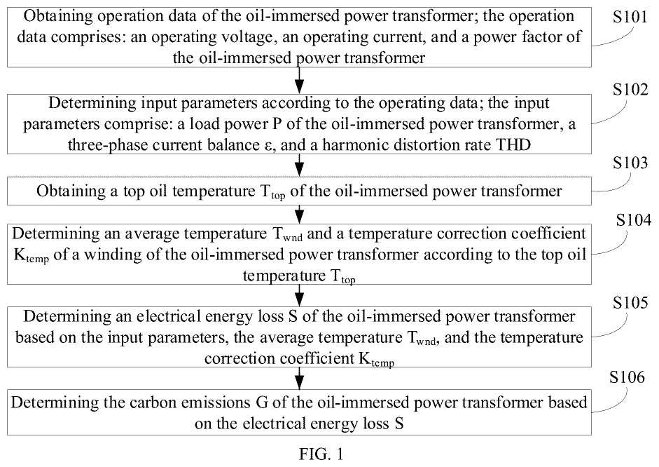

Referring to FIG. 1, FIG. 1 is a schematic flow diagram of a method for calculating carbon emissions according to an embodiment of the present application, this method is used for calculating carbon emissions of an oil-immersed power transformer. As shown in FIG. 1, this method is applied to an electronic device and includes steps 101-106. Wherein,

At step S101, operation data of the oil-immersed power transformer is obtained, the operation data includes an operating voltage, an operating current and a power factor of the oil-immersed power transformer.

In some possible implementations, the operation data of the oil-immersed power transformer may be extracted from a power grid information management system, the operation data includes three-phase (a, b, c) voltage effective values Uₐ, U_{b}, U_{c}, and corresponding voltage waveforms, three-phase current effective values Iₐ, I_{b}, I_{c} and corresponding current waveforms, and three-phase power factors cosφₐ, COSφ_{b}, COSφ_{c}.

At step S102, input parameters are determined according to the operation data. The input parameter includes a load power P, a three-phase current balance degree ε, and a harmonic distortion rate THD of the oil-immersed power transformer.

In some possible implementations, the input parameters may be determined according to the operation data, and a following calculation method may be used:

$$P = {U}_{a} {I}_{a} cos {φ}_{a} + {U}_{b} {I}_{b} cos {φ}_{b} + {U}_{c} {I}_{c} cos {φ}_{c}$$

$$ε = {( {I}_{a} - {I}_{b} )}^{2} + {( {I}_{a} - {I}_{c} )}^{2} + {( {I}_{b} - {I}_{c} )}^{2}$$

$$THD = \sqrt{{\sum }_{i = 2}^{n} {I}_{i}^{2}} / {I}_{1} \times 100 \%$$

Wherein, Iᵢ (i≥2) represents an effective value of a i-th harmonic current of a current waveform, I₁ represents an effective value of a 50 Hz fundamental current; Uₐ, U_{b}, U_{c} are the effective values of the three phase voltages a, b and c; Iₐ, I_{b}, I_{c} are three-phase (a, b, c) current effective values; cosφₐ, cosφ_{b}, cosφ_{c} are three-phase power factors.

At step S103, the top oil temperature Tₜₒₚ of the oil-immersed power transformer is obtained.

In some possible implementations, the top oil temperature Tₜₒₚ may be read from an oil temperature gauge on the oil-immersed power transformer or from online monitoring data of the current oil-immersed power transformer.

At step S104, an average temperature T_{wnd} and a temperature correction coefficient Kₜₑₘₚ of a winding of the oil-immersed power transformer are determined according to the top oil temperature Tₜₒₚ.

In some possible implementations, the average temperature T_{wnd} and the temperature correction coefficient Kₜₑₘₚ of the winding of the oil-immersed power transformer are determined according to the top oil temperature Tₜₒₚ. The following calculation method may be used:

$${T}_{wnd} = {T}_{top} - Δ {T}_{top - oi1} + Δ {T}_{wnd - oil} = {T}_{top} - {( \frac{1 + {R ( P / {P}_{std} )}^{2}}{1 + R} )}^{x} Δ {T}_{t - o - std} + {( \frac{P}{{P}_{std}} )}^{y} Δ {T}_{w - o - std}$$

wherein, the ΔTₜₒₚ₋ₒᵢₗ represents a difference value between the top oil temperature Tₜₒₚ and the average oil temperature T_{wnd}, the ΔT_{wnd-oil} represents a difference value between an average temperature of the winding and the average oil temperature T_{wnd}, the P_{std} represents a rated capacity of the oil-immersed power transformer, the R represents a loss ratio which is a ratio of the load loss of the oil-immersed power transformer to a no-load loss of the oil-immersed power transformer, the ΔT_{t-o-std} and the ΔT_{w-o-std} are the ΔTₜₒₚ₋ₒᵢₗ and the ΔT_{wnd-oil} of the oil-immersed power transformer at a rated voltage and a rated current, the x and the y are correction coefficients of oil temperature rise and winding temperature rise, respectively. Regarding the values of R, ΔT_{t-o-std}, ΔT_{w-o-std}, x and y, reference can be made to the table one.

TABLE 1

| Device | | | | | | |
|---|---|---|---|---|---|---|
| type and | Oil | | | | | |
| voltage | circulation | | | | | |
| level | mode | R/dimensionless | ΔT_{t-o-std}/° C. | ΔT_{w-o-std}/° C. | x/dimensionless | y/dimensionless |
| Distribution | Nature | 5 | 11 | 21 | 0.8 | 1.6 |
| transformer | oil | | | | | |
| (35 KV and | circulation | | | | | |
| below) | | | | | | |
| Middle | Nature | 6 | 9 | 20 | 0.9 | 1.6 |
| and large | oil | | | | | |
| size | circulation | | | | | |
| transformer | (ON) | | | | | |
| (110 kV and | Nature | 6 | 10 | 17 | 1.0 | 1.6 |
| above) | oil | | | | | |
| | circulation | | | | | |
| | (OF) | | | | | |
| | Forced | 6 | 3 | 22 | 1.0 | 2.0 |
| | oil | | | | | |
| | circulation | | | | | |
| | guidance | | | | | |
| | (OD) | | | | | |

$${K}_{temp} = \frac{{T}_{wnd} + C}{{T}_{wnd - std} + C}$$

Wherein, Twnd represents the average temperature of the winding at a rated state, with a reference value of 85° C.; C represents a coefficient related to the material of the winding, 235 is selected for the winding having copper material, and 225 is selected for the winding having an aluminum material.

At step S105, an electrical energy loss S of the oil-immersed power transformer is determined according to the input parameters, the average temperature T_{wnd}, and the temperature correction coefficient Kₜₑₘₚ.

In some possible implementations, the electrical energy loss S of the oil-immersed power transformer may be determined according to the input parameters, the average temperature T_{wnd} and the temperature correction coefficient Kₜₑₘₚ. A following calculation method may be used:

$$S = {K}_{temp} {P}_{c} + {P}_{i} + {K}_{temp} Δ {P}_{c 1} + Δ {P}_{i 1} + {K}_{temp} Δ {P}_{c 2} + Δ {P}_{i 2} = {{K}_{temp} ( \frac{P}{{P}_{std}} )}^{2} {P}_{c} + {P}_{i} + {K}_{temp \_ 1} {R}_{1} ε / 3 + {K}_{F e 1} {R}_{F e} ε + {K}_{temp} THD {( \frac{P}{{P}_{std}} )}^{2} {P}_{c} + {K}_{i \_ THD} {THDP}_{i}$$

wherein P_{c} is the load loss at the rated state, and the Pᵢ is the no-load loss at the rated state; the ΔP_{c1} represents an additional copper loss when three-phase imbalance is considered, the K_{temp_1}=(T_{wnd}+C)/(T_{R1_std}+C) represents a temperature correction coefficient of a direct current resistance of a secondary winding, the T_{R1_std} represents an ambient temperature during testing of the direct current resistance of the secondary winding; the ΔPᵢ₁ represents an additional iron loss when the three-phase imbalance is considered, and is obtained through an equivalent resistance value R_{Fe} of an eddy current loss between a clamp and an oil tank, an additional iron loss coefficient K_{Fe1}, and the three-phase current balance ε, the R_{Fe} and K_{Fe1} are calculated by a manufacturer through numerical analysis and calculation of electromagnetic field of the transformer; the ΔP_{c2} represents the additional copper loss with the consideration of harmonics; the ΔPᵢ₂ represents the additional iron loss with the consideration of harmonics, and the K_{i_THD} is calculated by the manufacturer through the numerical analysis of the electromagnetic field of the transformer.

At step S106, the carbon emission G of the oil-immersed power transformer is determined according to the electrical energy loss S.

In some possible implementations, a following calculation method of calculating the carbon emission of the oil-immersed power transformer within a certain time period may be used to determine the carbon emission G of the oil-immersed power transformer according to the electrical energy loss S;

$$G = S \cdot {t}_{R} \cdot EF$$

wherein, the t_{R} represents the operating time, the EF represents a carbon emission factor of a power grid which is calculated according to public data from various environmental departments in various regions.

The historical operation data of a transformer (oil-immersed three-phase dual windings on load voltage regulation power transformer, the windings are made of oxygen free copper material, the power transformer has a rated voltage of 35 kV and a rated power of 6300 kVA) of a transformer substation #1, lasting from Apr. 1, 2020 to Apr. 10, 2020, for a total of 40 days, are used, three-phase voltages {Uₐ, U_{b}, U_{c}}, three-phase currents {Iₐ, I_{b}, I_{c}}, and various phase power factors {cosφₐ,cosφ_{b}, cosφ_{c}} without consideration of three-phase imbalance are included. A load power P of the transformer, a three-phase current balance ε, and a harmonic distortion rate THD are calculated using the following formula based on the historical operating data of the voltages and the currents.

An electric power inspection robot or an electric power inspection drone is adopted to photograph the top oil temperature gauge of the transformer #1 from Apr. 1, 2020 to Apr. 10, 2020, every 4 hours and 6 times a day. 6 measured top oil temperature data are obtained according to the acquired images, and an average value of the 6 measured top oil temperature data is calculated to obtain the top oil temperature value Tₜₒₚ for that day.

The detailed data is shown in table 2.

TABLE 2

| Date | P/kW | ε/A² | THD | Tₜₒₚ/° C. |
|---|---|---|---|---|
| 2020 Apr. 1 | 3924.9 | 33.42 | 2.92% | 53 |
| 2020 Apr. 2 | 3856.6 | 27.00 | 2.01% | 56 |
| 2020 Apr. 3 | 3824.3 | 25.65 | 2.31% | 52 |
| 2020 Apr. 4 | 3684.1 | 33.14 | 1.71% | 54 |
| 2020 Apr. 5 | 3523.4 | 32.17 | 2.22% | 53 |
| 2020 Apr. 6 | 4012.2 | 30.31 | 2.38% | 57 |
| 2020 Apr. 7 | 3945.7 | 29.91 | 3.38% | 57 |
| 2020 Apr. 8 | 3965.4 | 28.04 | 3.37% | 55 |
| 2020 Apr. 9 | 3844.9 | 28.99 | 2.09% | 56 |
| 2020 Apr. 10 | 3996.8 | 27.62 | 3.39% | 57 |

According to the data listed above, the average temperature T_{wnd} and the temperature correction coefficient Kₜₑₘₚ during loss calculation are obtained and shown in table 3.

TABLE 3

| Date | T_{wnd}/° C. | Kₜₑₘₚ |
|---|---|---|
| 2020 Apr. 1 | 57 | 0.91 |
| 2020 Apr. 2 | 59 | 0.92 |
| 2020 Apr. 3 | 55 | 0.91 |
| 2020 Apr. 4 | 57 | 0.91 |
| 2020 Apr. 5 | 56 | 0.91 |
| 2020 Apr. 6 | 61 | 0.92 |
| 2020 Apr. 7 | 61 | 0.92 |
| 2020 Apr. 8 | 59 | 0.92 |
| 2020 Apr. 9 | 59 | 0.92 |
| 2020 Apr. 10 | 61 | 0.92 |

According to factory test and finite element simulation data of the manufacturer of the transformer, a rated no-load loss Pᵢ is equal to 3.24 kW, a rated load loss P_{c} is 31.08 kW, a secondary side resistance value R₁ is 2.08 Ω (the ambient temperature during testing is 20° C.), an equivalent resistance value R_{Fe} of eddy current loss between the clamp and the oil tank is 35 Ω, an additional iron loss coefficient K_{Fe1} is 0.9, and a harmonic eddy current iron loss coefficient K_{i-THD} is 1.2.

Referring to the Notice of the Ministry of Ecology and Environment on doing a Good Job in the Management of Greenhouse Gas Emission Reports for Power Generation Industry Enterprises from 2023 to 2025, the carbon emission factor EF of the power grid is determined as 0.5703 tons (_{CO2})/MW·h.

Due to the need of calculating carbon emissions within one day, t_{w} is set to 24 hours.

Based on the above data, the electrical energy loss power S and daily carbon emissions G of the transformer are shown in Table 4.

TABLE 4

| Date | S/kW | G/ton_{(CO2)} |
|---|---|---|
| 2020 Apr. 1 | 16.65 | 0.2279 |
| 2020 Apr. 2 | 15.85 | 0.2170 |
| 2020 Apr. 3 | 15.48 | 0.2119 |
| 2020 Apr. 4 | 15.14 | 0.2072 |
| 2020 Apr. 5 | 14.26 | 0.1952 |
| 2020 Apr. 6 | 17.06 | 0.2335 |
| 2020 Apr. 7 | 16.79 | 0.2298 |
| 2020 Apr. 8 | 16.72 | 0.2288 |
| 2020 Apr. 9 | 15.91 | 0.2178 |
| 2020 Apr. 10 | 16.96 | 0.2322 |

In the present application, when carbon emissions are calculated, the required input may be obtained from nameplate data of equipment, factory test data, and three-phase voltage and current data in the power recording system, which is applicable for rapid estimation of carbon emissions of on-site power transformers with high accuracy.

An electronic device is further provided in the embodiments of the present application. The electronic device may include a memory and one or a plurality of processors coupled with the memory. Wherein, the memory stores a computer program code, the computer program code includes a computer instruction, when the computer instruction is executed by the processor, the electronic device is caused to perform the steps in the various method embodiments.

A non-transitory computer-readable storage medium is further provided in the embodiments of the present application, the computer-readable storage medium stores a computer instruction, that, when being executed by the processor of the electronic device, causes the processor of the electronic device to perform the steps in the various method embodiments.

A computer program product is further provided in the embodiments of the present application, the computer program product includes a computer program, that, when executed by the processor, implement the steps in the various method embodiments.

In the embodiments of the present application, the descriptions of the embodiments in the present application are emphasized respectively, regarding the part in some embodiments which is not described in detail, reference can be made to related descriptions in other embodiments.

The person of ordinary skill in the art may understand that, the elements and algorithm steps of each of the examples described in connection with the embodiments disclosed herein may be implemented in electronic hardware, or in combination with computer software and electronic hardware. Whether these functions are implemented by hardware or software depends on the specific application and design constraints of the technical solution. The skilled people could use different methods to implement the described functions for each particular application, however, such implementations should not be considered as going beyond the scope of the present application.

It should be understood that, in the embodiments of the present application, the disclosed method/electronic device could be implemented in other ways. For example, the device/network device embodiments described above are merely illustrative; for example, the division of the units is only a logical function division, and other division could be used in the actual implementation, for example, multiple units or components could be combined or integrated into another system, or some features may be ignored, or not performed. In another aspect, the coupling or direct coupling or communicating connection shown or discussed could be an indirect coupling or a communicating connection through some interfaces, devices or units, and the coupling or direct coupling or communicating connection could be electrical, mechanical, or in other form.

The units described as separate components can be or cannot be physically separate, the components shown as units can be or cannot be physical units, the components may be located in one place, or be distributed onto multiple network elements. A part or a whole of the elements can be selected to achieve the objective of the technical solution of this embodiment according to the actual requirement.

It should be understood that, when a term “comprise/include” is used in the description and annexed claims, the term “comprise/include” indicates existence of the described characteristics, integer, steps, operations, elements and/or components, but not exclude existence or adding of one or more other characteristics, integer, steps, operations, elements, components and/or combination thereof.

It should be further understood that, terms “and/or” used in the description and the annexed claims of the present application are referred to as any combination of one or a plurality of listed item(s) associated with each other and all possible items, and including the combinations thereof.

The descriptions of “referring to one embodiment” and “referring to some embodiments”, and the like as described in the specification of the present application means that a specific feature, structure, or characters which are described with reference to this embodiment are included in one embodiment or some embodiments of the present application. Thus, the sentences of “in one embodiment”, “in some embodiments”, “in some other embodiments”, “in other embodiments”, and the like in this specification are not necessarily referring to the same embodiment, but instead indicate “one or more embodiments instead of all embodiments”, unless there is a special emphasis in other manner otherwise. The terms of “comprising”, “including”, “having” and their variations mean “including but is not limited to”, unless otherwise they are specially emphasized in other manner.

The aforesaid embodiments are merely used to explain the technical solutions of the present application, and are not intended to limit the technical solutions of the present application. Although the present application has been described in detail with reference to the embodiments described above, a person of ordinary skill in the art should understand that the technical solutions described in these embodiments may still be modified, or some or all technical features in the embodiments may be equivalently replaced. However, these modifications or replacements do not make the essences of corresponding technical solutions to deviate from the spirit and the scope of the technical solutions of the embodiments of the present application, and should all be included in the protection scope of the present application.

1. A method for calculating carbon emissions of an oil-immersed power transformer, being applied to an electronic device, the method comprising:
obtaining operation data of the oil-immersed power transformer; the operation data comprises: an operating voltage, an operating current, and a power factor of the oil-immersed power transformer;
determining input parameters according to the operating data; wherein the input parameters comprise: a load power P of the oil-immersed power transformer, a three-phase current balance ε, and a harmonic distortion rate THD;
obtaining a top oil temperature Tₜₒₚ of the oil-immersed power transformer;
determining an average temperature T_{wnd} and a temperature correction coefficient Kₜₑₘₚ of a winding of the oil-immersed power transformer according to the top oil temperature Tₜₒₚ;
determining an electrical energy loss S of the oil-immersed power transformer based on the input parameters, the average temperature T_{wnd}, and the temperature correction coefficient Kₜₑₘₚ; and
determining the carbon emission G of the oil-immersed power transformer based on the electrical energy loss S.

2. The method according to claim 1, wherein said determining the input parameters according to the operation data comprises:
$$P = {U}_{a} {I}_{a} cos {φ}_{a} + {U}_{b} {I}_{b} cos {φ}_{b} + {U}_{c} {I}_{c} cos {φ}_{c}$$
$$ε = {( {I}_{a} - {I}_{b} )}^{2} + {( {I}_{a} - {I}_{c} )}^{2} + {( {I}_{b} - {I}_{c} )}^{2}$$
$$THD = \sqrt{{\sum }_{i = 2}^{n} {I}_{i}^{2}} / {I}_{1} \times 100 \%$$
wherein, the Iᵢ (i≥2) represents an effective value of an i-th harmonic current of a current waveform, I₁ represents an effective value of a fundamental current of 50 Hz; the Uₐ, the U_{b}, and the U_{c} represent effective values of three-phase voltages of a, b, and c; the Iₐ, the I_{b}, and the I_{c} represent effective values of three-phase currents of a, b, and c; the cosφa, the cosφb, the cosφc represent three-phase power factors.

3. The method according to claim 2, wherein said determining the average temperature T_{wnd} and the temperature correction coefficient Kₜₑₘₚ of the winding of the oil-immersed power transformer according to the top oil temperature Tₜₒₚ comprises:
$${T}_{wnd} = {T}_{top} - Δ {T}_{top - oil} + Δ {T}_{wnd - oil} = {T}_{top} - {( \frac{1 + {R ( P / {P}_{std} )}^{2}}{1 + R} )}^{x} Δ {T}_{t - o - std} + {( \frac{P}{{P}_{std}} )}^{y} Δ {T}_{w - o - std}$$
wherein, the ΔTₜₒₚ₋ₒᵢₗ represents a difference value between the top oil temperature Tₜₒₚ and the average oil temperature T_{wnd}, the ΔT_{wnd-oil} represents a difference value between an average temperature of the winding and the average oil temperature T_{wnd}, the P_{std} represents a rated capacity of the oil-immersed power transformer, the R represents a loss ratio which is a ratio of the load loss of the oil-immersed power transformer to a no-load loss of the oil-immersed power transformer, the ΔT_{t-o-std} and the ΔT_{w-o-std} are the ΔTₜₒₚ₋ₒᵢₗ and the ΔT_{wnd-oil} of the oil-immersed power transformer at a rated voltage and a rated current, the x and the y are correction coefficients of oil temperature rise and winding temperature rise, respectively;
$${K}_{temp} = \frac{{T}_{wnd} + C}{{T}_{wnd - std} + C}$$
wherein, the T_{wnd} represents an average temperature of the winding at a rated state; the C is a coefficient related to a material of the winding.

4. The method according to claim 3, wherein said determining the electrical energy loss S of the oil-immersed power transformer according to the input parameters, the average temperature T_{wnd}, and the temperature correction coefficient Kₜₑₘₚ comprises:
$$S = {K}_{temp} {P}_{c} + {P}_{i} + {K}_{temp} Δ {P}_{c 1} + Δ {P}_{i 1} + {K}_{temp} Δ {P}_{c 2} + Δ {P}_{i 2} = {{K}_{temp} ( \frac{P}{{P}_{std}} )}^{2} {P}_{c} + {P}_{i} + {K}_{temp \_ 1} {R}_{1} ε / 3 + {K}_{F e 1} {R}_{F e} ε + {K}_{temp} {THD ( \frac{P}{{P}_{std}} )}^{2} {P}_{c} + {K}_{i \_ THD} {THDP}_{i}$$
wherein, the P_{c} is the load loss at the rated state, and the Pᵢ is the no-load loss at the rated state; the ΔP_{c1} represents an additional copper loss when three-phase imbalance is considered, the K_{temp_1}=(T_{wnd}+C)/(T_{R1_std}+C) represents a temperature correction coefficient of a direct current resistance of a secondary winding, the T_{R1_std} represents an ambient temperature during testing of the direct current resistance of the secondary winding; the ΔPᵢ₁ represents an additional iron loss when the three-phase imbalance is considered, which is obtained through an equivalent resistance value R_{Fe} of an eddy current loss between a clamp and an oil tank, an additional iron loss coefficient K_{Fe1}, and the three-phase current balance ε, the R_{Fe} and K_{Fe1} are calculated by a manufacturer through numerical analysis and calculation of electromagnetic field of the transformer; the ΔP_{c2} represents the additional copper loss with the consideration of harmonics; the ΔPᵢ₂ represents the additional iron loss with the consideration of harmonics, and the K_{i_THD} is calculated by the manufacturer through the numerical analysis of the electromagnetic field of the transformer.

5. The method according to claim 4, wherein said determining the carbon emission G of the oil-immersed power transformer according to the electrical energy loss S comprises:
calculating the carbon emissions of the oil-immersed power transformer within a certain time period, which is expressed as:
$$G = S \cdot {t}_{R} \cdot EF$$
wherein the t_{R} represents the operating time, the EF represents a carbon emission factor of a power grid which is calculated according to public data from various environmental departments in various regions.

6-8. (canceled)

9. An electronic device, comprising a memory and one or a plurality of processor(s) coupled with the memory; wherein the memory stores a computer program, that, when executed by the processor of the electronic device, causes the processor of the electronic device to perform the method according to claim 1.

10. A non-transitory computer-readable storage medium, wherein the computer-readable storage medium stores a computer instruction, that, when being executed on an electronic device, causes the electronic device to perform the method according to claim 1.
